(19) United States
(12) Patent Application Publication
(10) Pub. No.: US 2017/0141884 A1
(43) Pub. Date: May 18, 2017

(54) USER EQUIPMENT, BASE STATION, AND EARLY DECODING METHOD FOR USER EQUIPMENT

(71) Applicant: MEDIATEK INC., Hsin-Chu (TW)

(72) Inventors: Xiu-Sheng LI, Hsinchu City (TW); Jeng-Yi TSAI, Hsinchu City (TW)

(21) Appl. No.: 14/906,076

(22) PCT Filed: Aug. 7, 2015
(86) PCT No.: PCT/CN2015/086322

§ 371 Date: Jan. 19, 2016

Related U.S. Application Data
(60) Provisional application No. 62/034,939, filed on Aug. 8, 2014.

(51) Int. Cl. H04L 5/00; H04W 72/04

(52) U.S. Cl. CPC H04L 5/005; H04W 72/042; H04W 72/0413; H04L 5/0055

(57) ABSTRACT

A user equipment, a base station, and an early decoding method for the user equipment are provided. The user equipment executes an early decoding method by disabling some specific frame early termination chances in a blind transport format detection decoding trials so as to reduce decoding complexity. The base station retrieves acknowledgement information transmitted from the UE to terminate transmitting a remaining part of a downlink data once the ACK information indicates an ACK response.

### CROSS-REFERENCES TO RELATED APPLICATIONS

This application claims the benefit of priority based on U.S. Provisional Application Ser. No. 62/034,939 filed on Aug. 8, 2014, which is hereby incorporated by reference in its entirety.

### BACKGROUND OF THE INVENTION

Field of the Invention

The present invention relates to a user equipment (UE), a base station, and an early decoding method for the UE. More particularly, the user equipment of the present invention disables some frame early termination (FET) chances when blind transport format detection (BTFD) is employed so as to reduce UE decoding complexity in downlink FET.

Descriptions of the Related Art

With the development of wireless communication technologies, wireless devices have been widely used. To satisfy users' demands for communication, various telecommunication standards have been developed. For example, universal mobile telecommunications system terrestrial radio access (UTRA) release 12 is one version in the third generation partnership project (3GPP) communication system.

In the UTRA release 12 standard, a new downlink transmission mode called “downlink data frame early termination (DL-FET)” is defined. To perform the DL-FET, a user equipment (UE) has to execute multiple early decoding trials when receiving downlink data transmitted from a base station. In addition, blind transport format detection (BTFD) is commonly used in downlink data frame transmission; however, it makes the decoding process even more complicated for the UEs when performing the DL-FET.

Accordingly, an urgent need exists in the art to provide an early decoding mechanism to reduce UE decoding complexity when the UE performs the DL-FET and uses the BTFD.

### SUMMARY OF THE INVENTION

The objective of the present invention is to provide an early decoding mechanism which disables some DL-FET chances when a user equipment (UE) performs the DL-FET and uses the BTFD. By the early decoding mechanism of the present invention, UE decoding complexity in DL-FET could be greatly reduced with almost no DL link gain loss.

To achieve the aforesaid objective, the present invention discloses a user equipment which comprises a transceiver and a processor. The transceiver is configured to receive a first downlink data and a second downlink data from a base station, wherein the second downlink data comes after the first downlink data. The processor is electrically connected to the transceiver and configured to perform a first early decoding procedure after an initial number of slots of the first downlink data have been received by the transceiver. The first early decoding procedure comprises the following steps: early decoding a first dedicated traffic channel (DTCH) from received slots of the first downlink data based on a without-dedicated control channel (DCCH) mode after a first number of slots of the first downlink data have been received by the transceiver; and disabling early decoding at least one of the first DTCH and a DCCH based on a with-DCCH mode until a second number of slots of the first downlink data have been received by the transceiver.

In addition, the present invention further discloses an early decoding method for use in a user equipment. The user equipment comprises a transceiver and a processor. The transceiver is configured to receive a first downlink data and a second downlink data from a base station. The second downlink data comes after the first downlink data. The processor is electrically connected to the transceiver. The early decoding method is executed by the processor and comprises the following step: performing a first early decoding procedure after the transceiver receives an initial number of slots of the first downlink data, wherein the first early decoding procedure comprises the following steps: early decoding a first dedicated traffic channel (DTCH) from received slots of the first downlink data based on a without-dedicated control channel (DCCH) mode after a first number of slots of the first downlink data have been received by the transceiver; and disabling early decoding at least one of the first DTCH and a DCCH based on a with-DCCH mode until a second number of slots of the first downlink data have been received.

To achieve the aforesaid objective, the present invention further discloses a base station cooperating with the aforesaid user equipment. The base station is configured to retrieve first ACK information from pairwise slots of an UL DPCCH that corresponds to the first downlink data and to terminate transmitting a remaining part of the first downlink data to the user equipment when the first ACK information indicates an ACK response. Then, base station is further configured to retrieve second ACK information from pairwise slots of an UL DPCCH corresponding to the second downlink data and to terminate transmitting a remaining part of the second downlink data to the user equipment when the second ACK information indicates an ACK response. In addition, the base station is further configured to disable retrieving the first ACK information from pairwise slots of an UL DPCCH corresponding to the first downlink data when the first downlink data includes the DCCH.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a user equipment 1 according to the first embodiment to the eleventh embodiment of the present invention;

FIGS. 2A-2B are schematic diagrams showing the first downlink data and the second downlink data of the present invention, respectively;

FIG. 3A is a flowchart diagram of a first early decoding procedure of an early decoding method according to the first embodiments of the present invention;

FIG. 3B is a table showing various exemplary implementations according to the first embodiments of the present invention;

FIG. 4A is a flowchart diagram of a second early decoding procedure of an early decoding method according to the second embodiments of the present invention;

FIG. 4B is a table showing various exemplary implementations according to the second embodiments of the present invention;

FIG. 5 is a flowchart diagram of a first early decoding procedure of an early decoding method according to the fifth, seventh and eighth embodiments of the present invention;

FIG. 6 is a flowchart diagram of a first early decoding procedure of an early decoding method according to the sixth and ninth embodiments of the present invention;

FIG. 7 is a flowchart diagram of a second early decoding procedure of an early decoding method according to the seventh embodiment of the present invention;

FIG. 8 is a flowchart diagram of a second early decoding procedure of an early decoding method according to the eighth and ninth embodiments of the present invention;

FIGS. 9A-9B are schematic diagrams showing the uplink data corresponding to the first downlink data and the uplink data corresponding to the second downlink data of the present invention, respectively;

FIGS. 10A and 10B are tables showing the number of the decoding trials for DL-FET in the worst case when the BTFD is used according to the embodiments of the present invention; and

FIG. 11 is a schematic view illustrating a schematic diagram showing data transmission between the base station 9 and the UE 1 of the present invention.

### DESCRIPTION OF THE PREFERRED EMBODIMENT

The present invention provides a user equipment (UE), a base station, and an early decoding method for the base station. In the following description, the present invention will be explained with reference to embodiments thereof. It shall be appreciated that, theses embodiments of the present invention are not intended to limit the present invention to any specific environment, applications or implementations described in these embodiments. Therefore, the description of these embodiments is only for purpose of illustration rather than to limit the present invention and the scope claimed in this application shall be governed by the claims. Additionally, in the following embodiments and the attached drawings, elements unrelated to the present invention are omitted from depiction; and dimensional relationships among individual elements in the attached drawings are illustrated only for ease of understanding, but not to limit the actual scale.

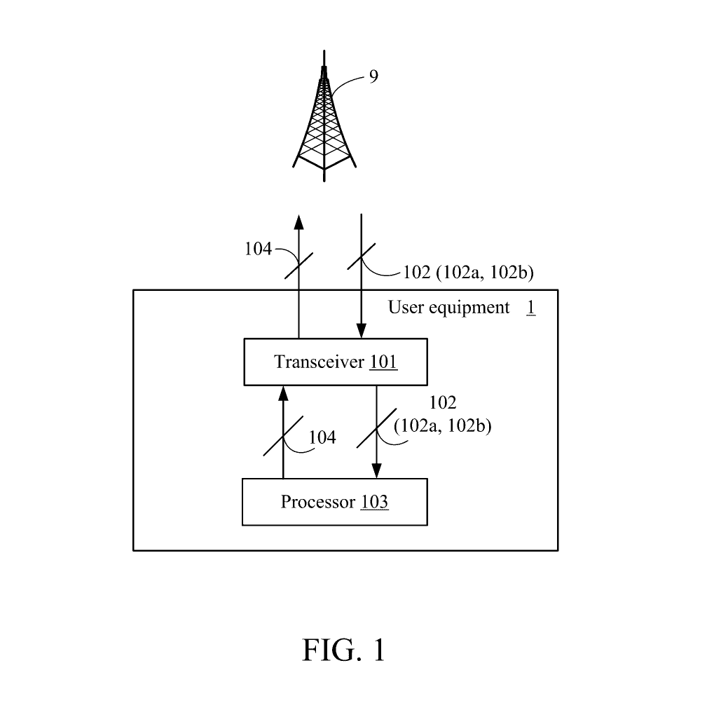

The first embodiment of the present invention is depicted in FIGS. 1, 2A-2B and 3A-3B. FIG. 1 is a schematic diagram of a UE 1 of the present invention. The UE 1 may be a smart phone, a tablet computer, or any other device with communication capability. It shall be noted that for the purpose of simplicity, other elements of the UE 1, such as a display module, an antenna module, a power module and elements less related to the present invention, are all omitted from depiction herein.

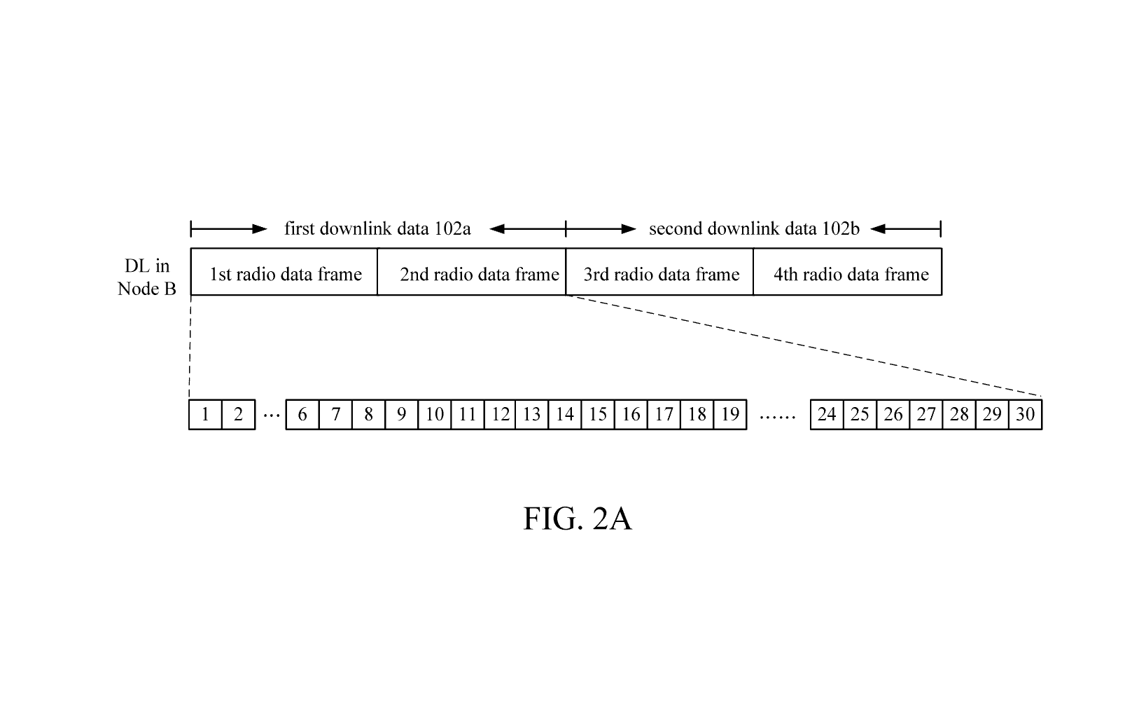

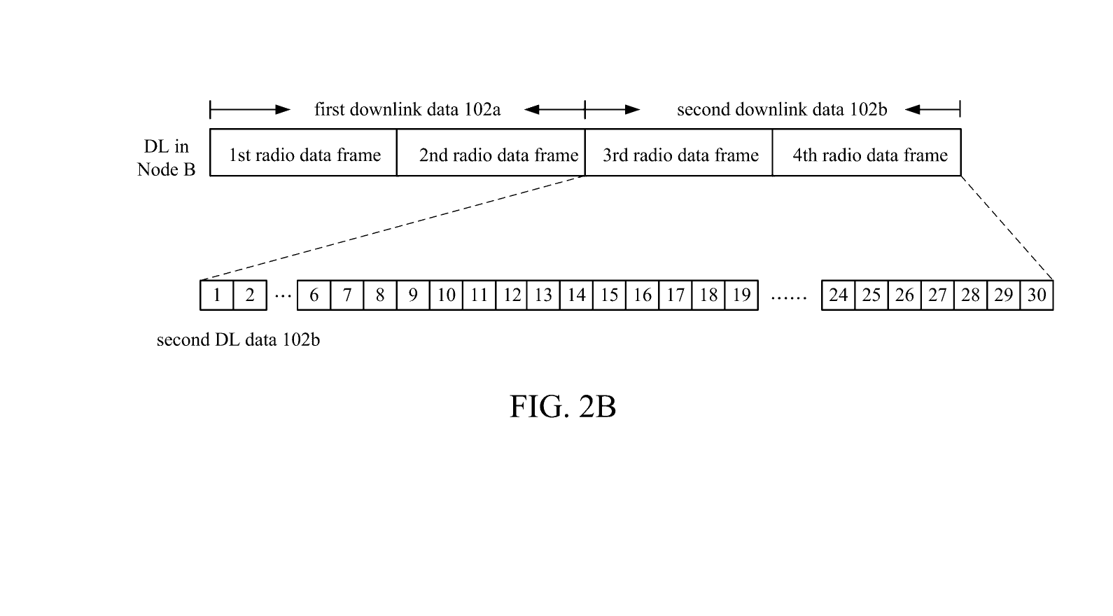

The UE 1 comprises a transceiver 101 and a processor 103 electrically connected to the transceiver 101. The transceiver 101 is configured to receive downlink data 102 which includes a first downlink data 102a and a second downlink data 102b from a base station 9. Specifically, the base station 9 may be designed to conform to the UTRA release 12 standard. As shown in FIGS. 2A-2B, the second downlink data 102b comes after the first downlink data 102a. Taking the specification of UTRA release 12 standard as an example, each of the first downlink data 102a and the second downlink data 102b includes two radio data frames occupying 30 slots. In detail, the 30 slots over the first and second radio data frames of the first downlink data 102a is shown in FIG. 2A, and the 30 slots over the third and fourth radio data frames of the second downlink data 102b is shown in FIG. 2B.

In general, a first dedicated traffic channel (DTCH) is split into two parts to be separately carried in the first and second radio data frames of the first downlink data 102a, and a second DTCH is split into two parts to be separately carried in the third and fourth radio data frames of the second downlink data 102b. Besides, in a case that the base station 9 has a control message to be sent to the UE 1, a dedicated control channel (DCCH) is split into four parts to be separately carried in the first and second radio data frames of the first downlink data 102a and the third and fourth radio data frames of the second downlink data 102b. In other words, the transmission time interval (TTI) of the DTCH is 20 milliseconds over two radio data frames, and the TTI of the DCCH is 40 milliseconds over four radio data frames.

It shall be appreciated that the DTCH carries the speech data and the DCCH carries the control message. Taking the adaptive multi-rate (AMR) 12.2 k speech service as an example, the DTCH has three packet types: mute, silence insertion descriptor (SID), full rate speech (FRS), and the DCCH only has one packet type. When the DL-FET is performed and the BTFD is used, the conventional UE needs to early decode the DTCH and the DCCH by trying all possible six decoding patterns: mute DTCH with DCCH, mute DTCH without DCCH, SID DTCH with DCCH, SID DTCH without DCCH, FRS DTCH with DCCH and FRS DTCH without DCCH on the downlink data. Therefore, the conventional BTFD makes the DL-FET procedure even more complicated for UE when the UE performs the DL-FET as aforementioned.

Compared to the conventional BTFD, the early decoding mechanism of the present invention disables some DL-FET chances when the UE performs the DL-FET and uses the BTFD, and will be described in detail. In the present invention, the processor 103 executes an early decoding method by reducing BTFD decoding trials. First, the processor 103 performs a first early decoding procedure after the initial number of slots of the first downlink data have been received by the transceiver. For example, the initial number of slots of the first downlink data might be set as 10 slots, which means that the processor 103 performs the first early decoding procedure after 10 slots of the first downlink data have been received.

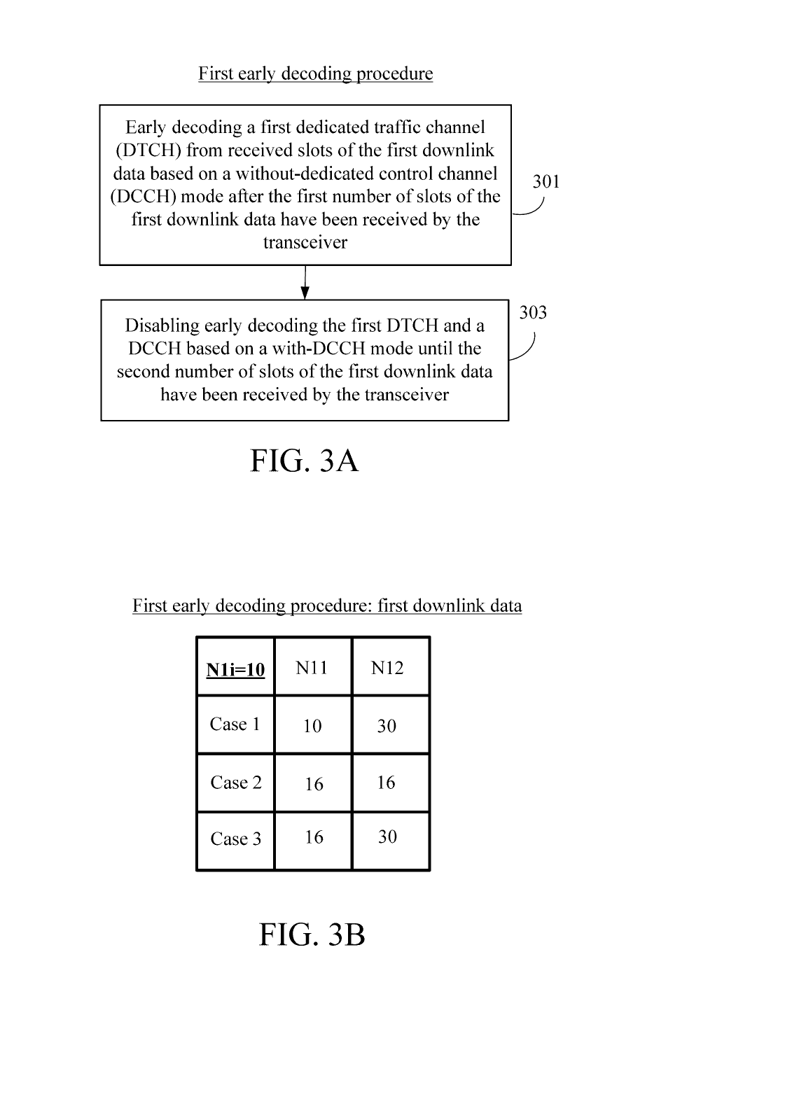

In detail, the processor 103 performs the first early decoding procedure as illustrated in FIG. 3A. In step 301, the processor 103 early decodes a first DTCH from received slots of the first downlink data 102a based on a without-dedicated control channel (DCCH) mode after the first number of slots of the first downlink data 102a have been received by the transceiver 101. Then, step 303 is executed to disable early decoding the first DTCH and a DCCH based on a with-DCCH mode until the second number of slots of the first downlink data have been received by the transceiver. In the without-DCCH mode, the processor 103 decodes the DTCH by trying the three decoding patterns: mute DTCH without DCCH, SID DTCH without DCCH, and FRS DTCH without DCCH. On the other hand, in the with-DCCH mode, the processor 103 decodes the DTCH by trying the other three decoding patterns: mute DTCH with DCCH, SID DTCH with DCCH and FRS DTCH with DCCH, and also decodes the DCCH by trying the three decoding patterns: mute DTCH with DCCH, SID DTCH with DCCH, and FRS DTCH with DCCH. It shall be noted that, in other embodiments, step 303 may be executed to disable early decoding only one of the first DTCH and a DCCH (instead of both the first DTCH and a DCCH as described above) based on a with-DCCH mode until the second number of slots of the first downlink data have been received by the transceiver 101.

For ease of explanation, the first number of slots of the first downlink data, the second number of slots of the first downlink data, and the initial number of slots of the first downlink data hereinbelow will be expressed as “N11”, “N12”, and “N1i”, respectively. In the later description, the cases that N11 is equal to or greater than N1i, the cases N12 is greater than N11 if N11 is equal to N1i, the cases that N12 is equal to N11 if N11 is greater than N1i, and the cases that N12 is different from (e.g., greater) N11 if N11 is greater than N1i will be further described by exemplary implementations. Especially, in one exemplary implementation, N11 can be equal to N1i, and N12 can be equal to the total number of slots of the first downlink data, which will be expressed as “N1t”.

In other words, in such the exemplary implementation, the processor 103 only uses the without-DCCH mode to early decode the first DTCH while the first early decoding procedure is performed. That is, the processor 103 disables chances to utilize the with-DCCH mode to early decode the first downlink data 102a during the first early decoding procedure. Instead, the processor 103 uses the with-DCCH mode to decode the first downlink data 102a (i.e., the first DTCH and/or the DCCH) only after the whole slots of the first downlink data 102a have been received.

Now it is assumed that the first downlink data 102a occupies 30 slots as shown in FIG. 2A. For example, as shown in case 1 of FIG. 3B, N11 is 10, which is equal to N1i, and N12 is 30. In case 1, the first early decoding procedure is performed by the processor 103 after 10 slots of the first downlink data 102a have been received. While the processor 103 initiates the first early decoding procedure, it also begins to use the without-DCCH mode to early decode the first DTCH of the first downlink data 102a. However, the with-DCCH mode is skipped during the first early decoding procedure. The with-DCCH mode would be used to decode the first DTCH and/or the DCCH only when the total slots (i.e., 30 slots) of the first downlink data 102a have been received.

It should be appreciated that, in case 1, the processor 103 decodes the first DTCH only on three patterns (without-DCCH mode): mute DTCH without DCCH, SID DTCH without DCCH, and FRS DTCH without DCCH; therefore, the processor 103 is unable to decode the first downlink data 102a successfully if there is DCCH included in the first downlink data 102a. Since the DCCH occurrence probability is low, disabling early decoding the DCCH and the first DTCH or the DCCH only introduces almost no link gain loss.

In another exemplary implementation, N11 is greater than N1i, and N12 is equal to N11. In this exemplary implementations, the processor 103 would postpone utilizing the without-DCCH mode and the with-DCCH mode to early decode the first DTCH and/or DCCH even though the first early decoding procedure has already been initiated. For example, as shown in case 2 of FIG. 3B, the processor 103 uses the without-DCCH mode and the with-DCCH mode, respectively, to early decode the first downlink data 102a after 16 slots of the first downlink data 102a have been received.

Furthermore, in one implementation, both N11 and N12 are greater than N1i, but N12 is greater than N11 rather than be equal to N11. In this exemplary implementations, the processor 103 would also postpone utilizing the without-DCCH mode and the with-DCCH mode to early decode the first DTCH and/or DCCH even though the first early decoding procedure has already been initiated. For example, as shown in case 3, the processor 103 postpones using the without-DCCH mode to early decode the first DTCH until 16 slots of the first downlink data 102a have been received; on the other hand, the with-DCCH mode would not be used to decode the first DTCH and the DCCH until the whole slots (i.e., 30 slots) of the first downlink data 102a have been received. It shall be noted that the cases illustrated in FIG. 3B are only exemplary implementations instead of limiting the scope of the present invention.

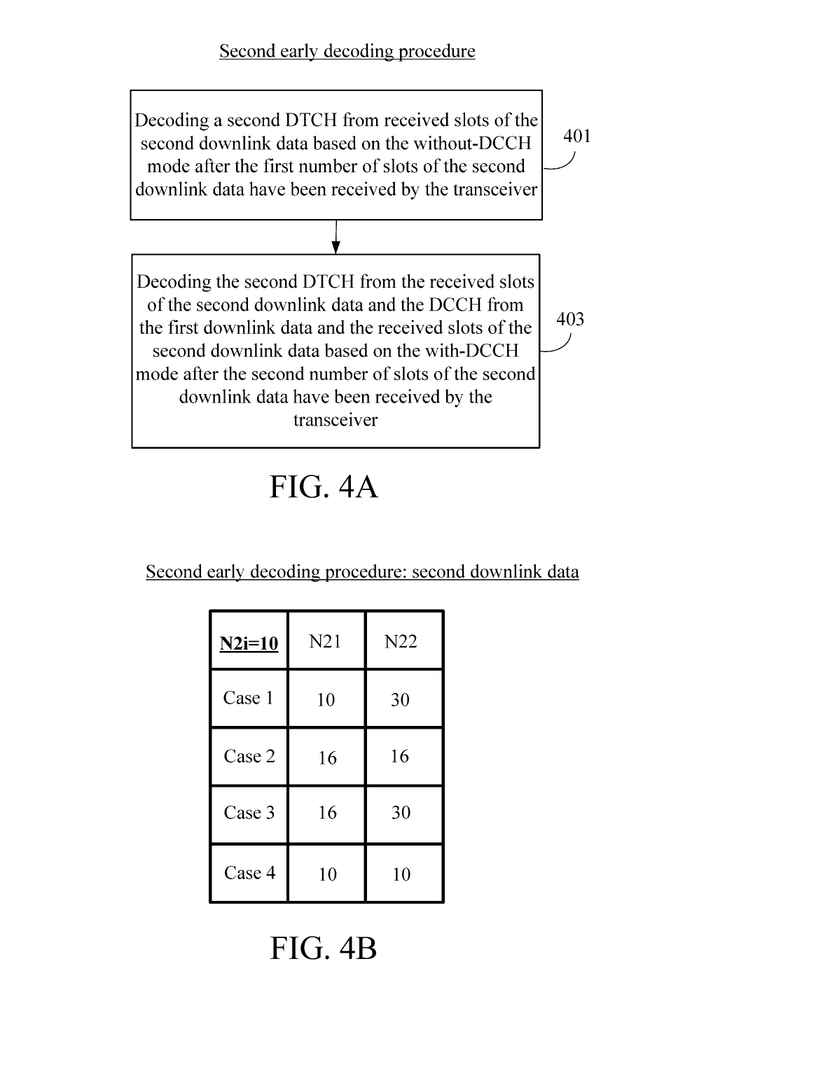

The second embodiment of the present invention is depicted in FIG. 4A-4B. The second embodiment is an extension of the first embodiment of the present invention. As shown in FIG. 4A, the processor 103 is further configured to perform a second early decoding procedure after the initial number of slots of the second downlink data 102b have been received by the transceiver 101. The second early decoding procedure will be described in detail below.

First, step 401 is executed to decode a second DTCH from received slots of the second downlink data 102b based on the without-DCCH mode after the first number of slots of the second downlink data 102b have been received by the transceiver 101. Then, step 403 is executed to decode the second DTCH from the received slots of the second downlink data 102b and to decode the DCCH from the first downlink data 102a and the received slots of the second downlink data 102b based on the with-DCCH mode after the second number of slots of the second downlink data 102b have been received by the transceiver 101. In detail, the first number of slots of the second downlink data 102b is equal to or greater than the initial number of slots of the second downlink data 102b, and the second number of slots of the second downlink data 102b is equal to or greater than the first number of slots of the second downlink data 102b.

Likewise, for ease of explanation, the first number of slots of the second downlink data 102b, the second number of slots of the second downlink data 102b, and the initial number of slots of the second downlink data 102b hereinbelow will be expressed as “N21”, “N22”, and “N2i”, respectively. More specifically, in one exemplary implementation, both N21 and N22 can be equal to N2i. In other exemplary implementations, only N21 is equal to N2i, and N22 is different from (e.g., greater than) N12. Moreover, in another exemplary implementation, both N21 and N22 are greater than N2i, and N21 and N22 can be equal to or different from each other (e.g., N22 is greater than N21, and N21 is greater than N2i). It shall be understood that the present invention does not limit the values of N2i, N21, and N22. Hence, there are many permutations of N2i, N21, and N22.

In one exemplary implementation, N21 is equal to N2i, and N22 is the total number of slots of the second downlink data 102b, which will be expressed as “N2t” hereinafter. For example, as shown in case 1 of FIG. 4B, the processor 103 would use the without-DCCH mode to early decode the second DTCH included in the second downlink data 102b once the transceiver 101 has received 10 slots of the second downlink data 102b (i.e., once the second early decoding procedure is performed). On the other hand, the processor 103 would not use the with-DCCH mode to early decode the second DTCH until the whole slots of the second downlink data 102b (e.g., 30 slots) have been received.

In case 2, the processor 103 would use the without-DCCH mode to early decode the second DTCH and the with-DCCH mode to early decode the second DTCH and the DCCH after receiving 16 slots of the second downlink data 102b. In other words, the processor 103 postpones utilizing the without-DCCH mode and the with-DCCH mode to early decode the second downlink data 102b. In case 3, the processor 103 also postpones utilizing the without-DCCH mode to early decode the second downlink data 102b until 16 slots of the second downlink data 102b have been received. In addition, the processor 103 decodes the second DTCH and the DCCH based on the with-DCCH mode only when the total slots of the second downlink data 102b (i.e., 30 slots) have been received, which means that the processor 103 disables using the with-DCCH mode to early decode the second downlink data 102b while the second early decoding procedure is performed.

Moreover, in case 4, the processor 103 would use both the without-DCCH mode and the with-DCCH mode to early decode the second downlink data 102b once the second early decoding procedure is initiated (i.e., once 10 slots of the second downlink data 102b have been received). It shall be noted that the cases illustrated in FIG. 4B are only exemplary implementations instead of limiting the scope of the present invention.

The third embodiment of the present invention is an extension of the previous embodiments. In this embodiment, the user equipment 1 of the present invention would further transmit the Acknowledgement (ACK) information to the base station 9 so as to inform the base station 9 of an early decoding result. That is, the ACK information is generated according to the early decoding results of the first downlink data 102a and the second downlink data 102b. Specifically, the processor 103 is further configured to fill ACK information into pairwise slots of an uplink dedicated physical control channel (UL DPCCH) which corresponds to the first downlink data 102a. In detail, the ACK information indicates either an ACK response or a negative-acknowledgment (NACK) response according to whether the first DTCH has been decoded successfully or not based on the without-DCCH mode, or whether the first DTCH and the DCCH have been decoded successfully or not based on the with-DCCH mode.

Similarly, the processor 103 is further configured to fill ACK information into pairwise slots of an uplink UL DPCCH which corresponds to the second downlink data 102b. The ACK information indicates either an ACK response or a NACK response according to whether the second DTCH has not been decoded successfully or not based on the without-DCCH mode, or whether both the second DTCH and the DCCH have been decoded successfully or not based on the with-DCCH mode. Accordingly, the base station 9 can terminate the transmission of the remaining parts of the first downlink data 102a and the second downlink data 102b so as to enhance the system capacity of the base station 9 and the user equipment 1.

The fourth embodiment is an extension of the previous embodiments of the present invention. In this embodiment, the early decoding method further includes the following operation: decoding the first DTCH from the first downlink data 102a based on the without-DCCH mode and the with-DCCH mode after receiving total slots of the first downlink data 102a (e.g., 30 slots) unless the first DTCH has been decoded successfully. It shall be appreciated that, in the case that if the DCCH has not been decoded successfully during the first early decoding procedure, the processor 103 may decode the DCCH again based on the with-DCCH mode after receiving the total slots of the first downlink data 102a (e.g., 30 slots). However, in other embodiments, the processor 103 may not try to decode the DCCH again at the end of the first downlink data 102a if the DCCH has not been decoded successfully. Instead, the processor 103 may decode the DCCH again after receiving a number of slots of the second downlink data 102b. In other words, the processor 103 shall decode the first DTCH and/or the DCCH again at the end of the first downlink data (e.g., at the end of the first 20 ms as shown in FIG. 2A) as long as the first DTCH and/or the DCCH have not been decoded successfully during the first early decoding procedure.

Likewise, when the processor 103 has not decoded the second downlink data 102b successfully after performing the second early decoding procedure, the processor 103 is further configured to decode the second downlink data 102b again after receiving the total slots of the second downlink data 102b. Specifically, the processor 103 decodes the second DTCH from the second downlink data 102b based on the without-DCCH mode and the with-DCCH mode after receiving the total slots of the second downlink data 102b unless the second DTCH has been decoded successfully, and decodes the DCCH from the first downlink data 102a and the second downlink data 102b based on the with-DCCH mode after receiving the total slots (e.g., 30 slots) of the second downlink data 102b unless the second DTCH has been decoded successfully based on the without-DCCH mode or the DCCH has been decoded successfully based on the with-DCCH mode. In other words, the processor 103 shall decode the second DTCH and/or the DCCH again at the end of the second downlink data 102b (e.g., at the end of the last 20 ms as shown in FIG. 2B) as long as the second DTCH and/or the DCCH have not been decoded successfully.

The fifth embodiment of the present invention is an exemplary implementation of the first embodiment. In this embodiment, it is assumed that each of the first downlink data 102a and the second downlink data 102b includes two radio data frames occupying 30 slots (i.e., 20 ms) as defined in the UTRA release 12 standard. To be more specific, the early decoding method in this embodiment includes the following operation: performing a first early decoding procedure after the transceiver 101 receives N+2*i slots of the first downlink data 102a until the first downlink data 102a has been decoded successfully or i reaches up to 9+X−Y; where i is a time variable and from 1 to 9+X−Y, and N is a start number and defined by Equation 1 as follows:

N=8−2×X+2×Y (Equation 1)

As shown in Equation 1, N is determined by a forward shift number X and a backward shift number Y. The forward shift number X ranges from 0 to 4, the backward shift number Y ranges from 0 to 8, and i is 1 to 9+X−Y. Specifically, the forward shift number X and the backward shift number Y are usually configured by the manufacturer. For most cases, the forward shift number X is configured to be 0. However, for some special purposes and applications, the forward shift number X may be one of 1 to 4. To simplify the description, only the case that the forward shift number X is equal to 0 will be described herein, and the case that the forward shift number X is not equal to 0 will be omitted from description since those of ordinary skill in the art can easily appreciate that the shift number X only affects the timing of executing the early decoding procedure as the backward shift number Y based on the following description.

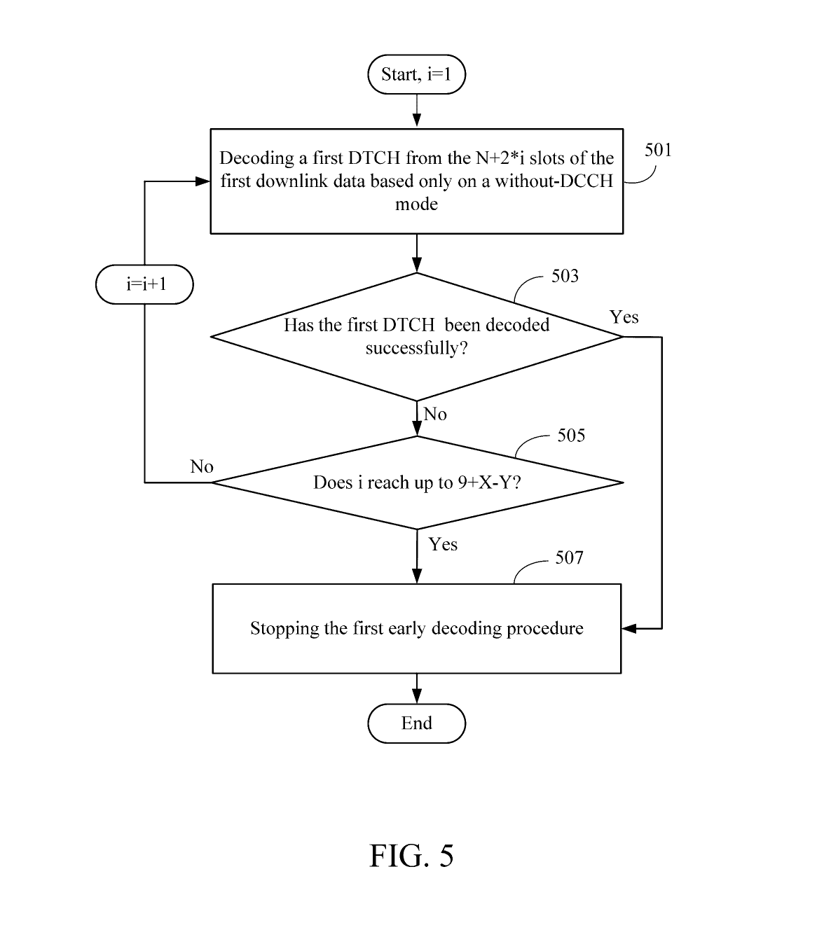

In this embodiment, the backward shift number Y is configured to be 0, and the processor 103 executes the first early decoding procedure as illustrated in FIG. 5. In the beginning, the time variable i starts with the value 1, which means that the first early decoding procedure is initiated when the N+2 slots (i.e., 10 slots) of the first downlink data 102a has been received by the transceiver 101. Then, step 501 is executed to decode a first dedicated traffic channel (DTCH) from the N+2*i slots of the first downlink data 102a based only on a without-dedicated control channel (DCCH) mode. In other words, in this embodiment, N11 is equal to N1i (i.e., 10), and N12 is 30, which means the UE 1 would not use the with-DCCH mode to early decode the first DTCH and the DCCH during the first decoding procedure.

Next, step 503 is executed to determine whether the first DTCH has been decoded successfully or not. If the first DTCH has not been decoded successfully, then step 505 is executed to determine whether time variable i reaches up to 9+X−Y or not. If it is determined “Yes” in step 505, step 507 is further executed to stop the first early decoding procedure, and the first early decoding procedure ends up. Otherwise, the time variable i is increased by 1 and the first early decoding procedure returns to step 501. On the other hand, if the first DTCH has been decoded successfully in step 503, the processor 103 executes step 507 to stop the first early decoding procedure, and then the first early decoding procedure ends up. In other words, the first early decoding procedure is terminated once the first DTCH has been decoded successfully or after the time variable i has reached up to 9+X−Y.

As described above, in the case that Y is equal to 0, the processor 103 disables the FET chances of early decoding the DTCH and the DCCH based on the three decoding patterns (i.e., the with-DCCH mode): mute DTCH with DCCH, SID DTCH with DCCH, and FRS DTCH with DCCH. That is, in this embodiment, the UE 1 would decode the first DTCH successfully only when the DCCH is not included in the first downlink data 102a. Thus, when the first downlink data 102a includes the DCCH, the processor 103 is unable to decode the first DTCH successfully since the processor 103 only utilizes the without-DCCH mode to decode the first DTCH.

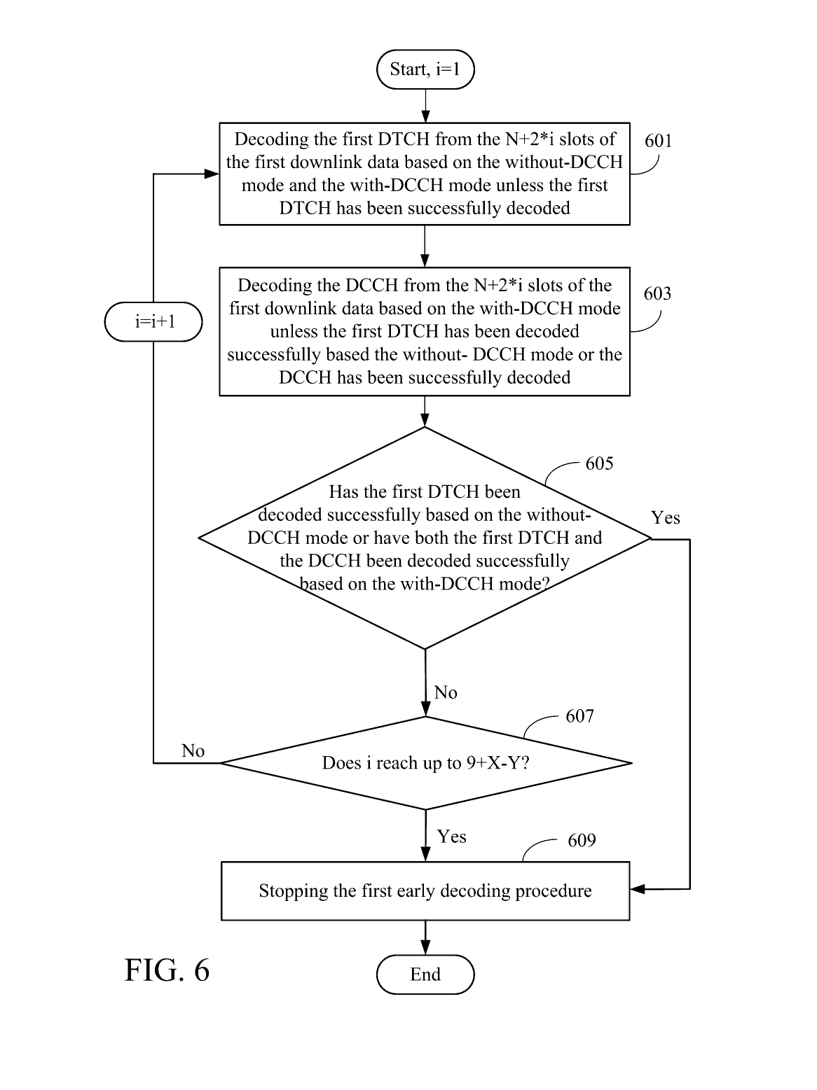

The sixth embodiment of the present invention is depicted in FIGS. 1, 2A-2B and 6. Different from the fifth embodiment, this embodiment depicts the first early decoding procedure when Y is not equal to 0. Similarly, the time variable i starts with the value 1 in the beginning, which means that the first early decoding procedure is initiated when the N+2 slots (e.g. 14 slots when Y=2) of the first downlink data 102a has been received by the transceiver 101. In other words, both N11 and N12 are greater than N1i (e.g., both N11 and N12 are 14, which are greater than N1i with a value 10), and the processor 103 postpones the timing of using the without-DTCH mode and the with-DTCH mode to early decode the first downlink data 102a.

Step 601 is executed to decode the first DTCH from the N+2*i slots of the first downlink data 102a based on the without-DCCH mode and the with-DCCH mode unless the first DTCH has been successfully decoded. And, step 603 is executed to decode a DCCH from the N+2*i slots of the first downlink data 102a based on the with-DCCH mode unless the first DTCH has been decoded successfully based on the without-DCCH mode or the DCCH has been successfully decoded based on the with-DCCH mode. It should be understood that in other embodiments, the execution order of steps 601 and 603 can be exchanged or steps 601 and 603 can be merged to one step.

Then, step 605 is executed to determine whether the first DTCH has been decoded successfully based on the without-DCCH mode or whether both the first DTCH and the DCCH have been decoded successfully based on the with-DCCH mode. If the first DTCH has been decoded successfully based on the without-DCCH mode or both the first DTCH and the DCCH have been decoded successfully based on the with-DCCH mode, the processor 103 executes step 609 to stop the first early decoding procedure, and then the first early decoding procedure ends up. On the other hand, if it is determined that the first DTCH has not been decoded successfully based on the without-DCCH mode and both the first DTCH and the DCCH have not been decoded successfully based on the with-DCCH mode, step 607 is executed to determine whether i reaches up to 9+X−Y or not. If the determination result is “No” in step 607, then the time variable i is increased by 1 and the first early decoding procedure returns to step 601. Otherwise, step 609 is executed to stop the first early decoding procedure, and then the first early decoding procedure ends up.

It can be seen that, in this embodiment, the processor 103 disables the FET chances of early decoding the DTCH and the DCCH by postponing the timing of executing the early decoding procedure. In other words, the processor 103 initiates to execute the early decoding procedure after the number of received slots of the first downlink data 102a exceeds 12 slots at least.

Those of ordinary skill in the art can easily understand that (i) the DCCH is rarely sent to the UE; and (ii) the possibility of successfully early decoding the DTCH and DCCH is proportional to the number of received slots of the downlink data. Considering the situation (i), the fifth embodiment of the present invention disables the FET chances by not trying to decoding both the DTCH and DCCH by the three decoding patterns: mute DTCH with DCCH, SID DTCH with DCCH, and FRS DTCH with DCCH. In addition, regarding the situation (ii), the sixth embodiment of the present invention disables the FET chances by initiating the early decoding procedure later until much more slots of the downlink data have been received.

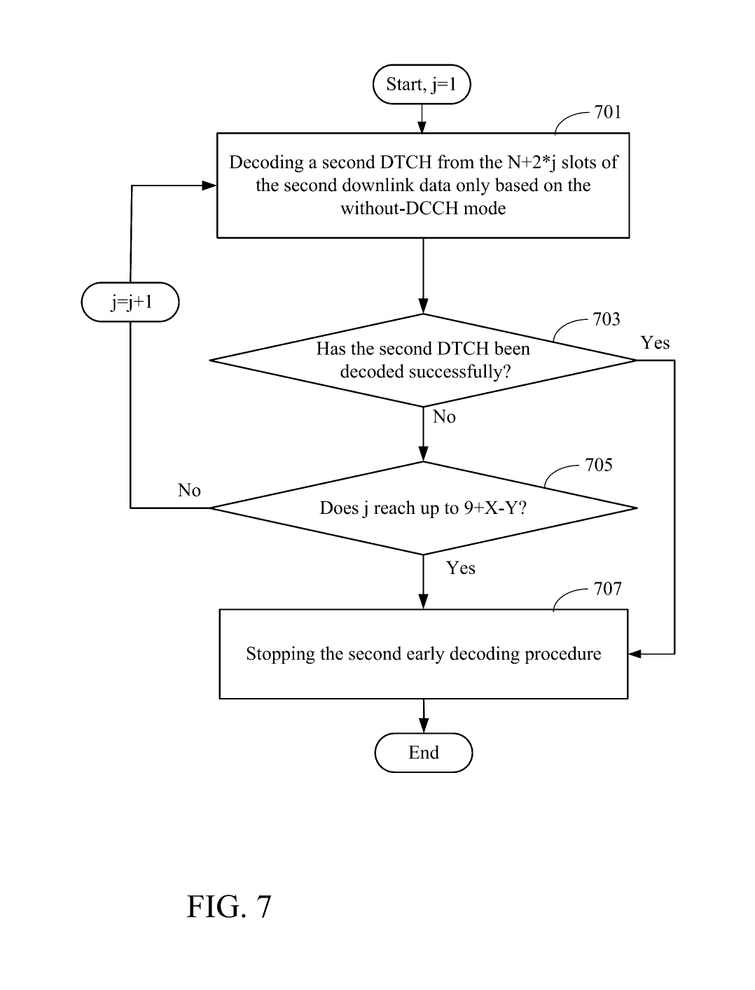

The seventh embodiment of the present invention is depicted in FIGS. 1, 2A-2B and 7. This embodiment is an extension of the fifth embodiment of the present invention. The early decoding method further includes the following operation: performing a second early decoding procedure after receiving N+2*j slots of the second downlink data 102b. As aforementioned, N is the start number and determined by the forward shift number X and the backward shift number Y. Similarly, j is a time variable and from 1 to 9+X−Y. As shown in FIG. 7, when the backward shift number Y is equal to 0, the second early decoding procedure is executed by the processor 103 and includes the following operations.

In the beginning, the time variable j starts with the value 1, which means that the second early decoding procedure is initiated when the N+2 slots of the second downlink data 102b have been received by the transceiver 101. Then, step 701 is executed to decode a second DTCH from the N+2*j slots of the second downlink data only based on the without-DCCH mode. In other words, in this embodiment, N21 is equal to N2i, and N22 is equal to N2t.

Next, step 703 is executed to determine whether the second DTCH has been decoded successfully or not. If the second DTCH has not been decoded successfully, step 705 is further executed to determine whether j value has reached up to 9+X−Y. If the determination result is “Yes” in step 705, step 707 is executed to stop the second early decoding procedure, and then the second early decoding procedure ends up. Otherwise, the time variable j is increased by 1 and the second early decoding procedure returns to step 701. On the other hand, if it is determined that the second DTCH has been decoded successfully in step 703, the processor 103 executes step 707 to stop the second early decoding procedure, and then the second early decoding procedure ends up.

In other words, in the case that the backward shift number Y is configured to be 0, the processor 103 of the present invention executes the second early decoding procedure in the same way as the first early decoding procedure described in the fifth embodiment. In this case, the UE 1 disables FET chances of early decoding the DTCH and the DCCH based on the three decoding patterns (i.e., the with-DCCH mode): mute DTCH with DCCH, SID DTCH with DCCH, and FRS DTCH with DCCH. That is, the UE 1 would decode the first downlink data 102a and the second downlink data 102b successfully only when the DCCH is not included in both of which. Therefore, when the second downlink data 102b includes the DCCH, the processor 103 is unable to decode the second downlink data 102b successfully since the processor 103 decodes the DTCH only based on the without-DCCH mode.

The eighth embodiment of the present invention is depicted in FIGS. 1, 2A-2B and 8. The present embodiment is also an extension of the fifth embodiment of the present invention. In this embodiment, the backward shift number Y is also configured to be 0. However, the UE 1 in this embodiment only disables FET chances of early decoding the first downlink data 102a which includes the DCCH (i.e., the UE 1 only utilizes the without-DCCH mode to decode the first downlink data 102a) as described in the fifth embodiment, and utilizes both the without-DCCH mode and the with-DCCH mode to decode the second downlink data 102b.

In this embodiment, the second early decoding procedure includes the following operations. In the beginning, the time variable j starts with the value 1, which means that the second early decoding procedure is initiated when the N+2 slots (i.e. 10 slots) of the second downlink data 102a have been received by the transceiver 101.

Then, step 801 is execute to decode the second DTCH from the N+2*j slots of the second downlink data 102b based on the without-DCCH mode and the with-DCCH mode unless the second DTCH has been successfully decoded. Next, step 803 is execute to decode the DCCH from the first downlink data 102a and the N+2*j slots of the second downlink data 102b based on the with-DCCH mode unless the second DTCH has been decoded successfully based on the without-DCCH mode or the DCCH has been successfully decoded. It should be understood that in other embodiments, the execution order of steps 801 and 803 can be exchanged or steps 801 and 803 can be merged to one step.

Afterwards, step 805 is executed to determine whether the second DTCH has been decoded successfully base on the without-DCCH mode or whether both the second DTCH and the DCCH have been decoded successfully based on the with-DCCH mode. If the second DTCH has not been decoded successfully based on the without-DCCH mode and both the second DTCH and the DCCH have not been decoded successfully based on the with-DCCH mode (i.e., the second downlink data 102b has not been decoded successfully based on the without-DCCH mode and the with-DCCH mode), then step 807 is executed to determine whether the j value has reached up to 9+X−Y. If the determination result is “Yes” in step 807, step 809 is executed to stop the second early decoding procedure, and then the second early decoding procedure ends up. Otherwise, the time variable j is increased by 1 and the second early decoding procedure returns to step 801. On the other hand, if the determination result is “Yes” in step 805, the processor 103 executes step 809 to stop the second early decoding procedure, and then the second early decoding procedure ends up.

The ninth embodiment of the present invention is also depicted in FIGS. 1, 2A-2B and 8, which is an extension of the sixth embodiment of the present invention. In the case that when the backward shift number Y is not configured to be 0, the UE 1 disables some earlier FET chances of early decoding the DTCH and the DCCH by postponing the timing of executing the early decoding procedure on the second downlink data 102b. In detail, in this embodiment, both N21 and N22 are greater than N2i (i.e., 10), and N21 is equal to N22. In other words, the processor 103 initiates to execute the second early decoding procedure after the number of received slots of the second downlink data 102b exceeds 12 slots at least.

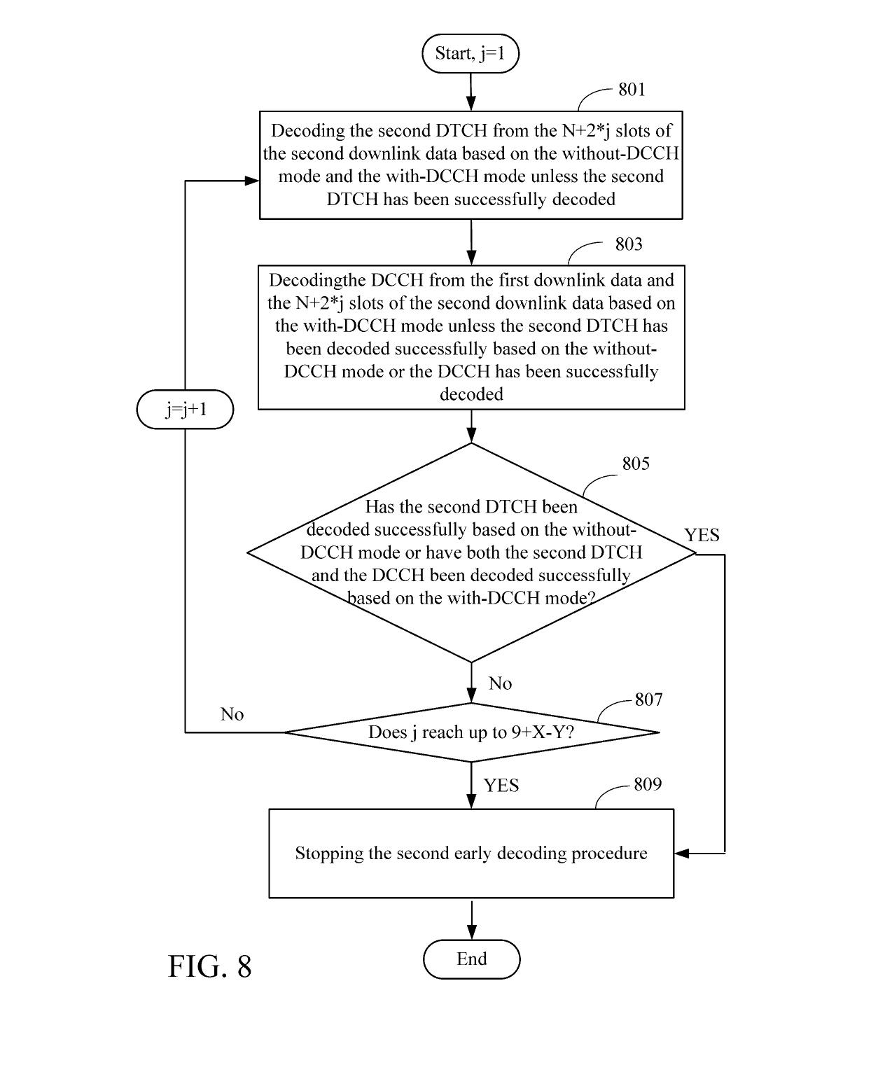

In this embodiment, the processor 103 also executes the second early decoding procedure as shown in FIG. 8, but the second early decoding procedure in this embodiment is initiated when at least 12 slots (e.g., N+2*j=12 when j=1 and Y=1) of the second downlink data 102b has been received by the transceiver 101. How this embodiment executes theses operation depicted in FIG. 8 when the backward shift number Y is not equal to 0 can be easily appreciated by those of ordinary skill in the art based on the foregoing description, and thus will not be further described herein.

In another embodiment, Y is also not configured to 0. However, in this embodiment, the processor 103 decodes the first DTCH from the N+2*i slots of the first downlink data 102a only based on the without-DCCH mode. In addition, the processor 103 decodes the second DTCH from the N+2*i slots of the second downlink data 102b also only based on the without-DCCH mode. In other words, in this embodiment, N11 (e.g., 14) is greater than N1i (i.e., 10), and N12 is equal to N1t (i.e., 30). Likewise, N21 (e.g., 14) is greater than N2i (i.e., 10), and N22 is equal to N2t (i.e., 30). In other embodiments, Y is also not configured to 0. Similarly, in this embodiment, the processor 103 decodes the first DTCH from the N+2*i slots of the first downlink data 102a only based on the without-DCCH mode. However, the processor 103 in this embodiment decodes the second DTCH from the N+2*i slots of the second downlink data 102b based on both the without-DCCH mode and the with-DCCH mode. In other words, in this embodiment, N11 (e.g., 14) is greater than N1i (i.e., 10), and N12 is equal to N1t (i.e., 30). On the other hand, N21 (e.g., 14) is greater than N2i (i.e., 10), and N22 is equal to N21 (i.e., 14).

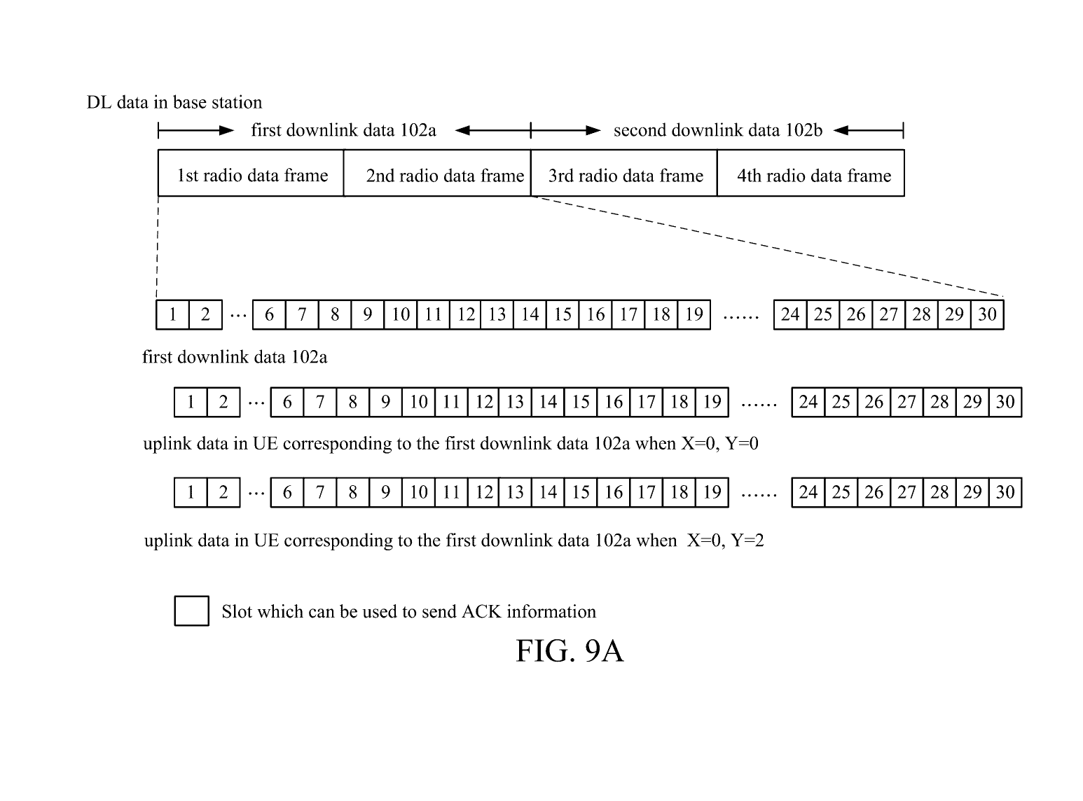

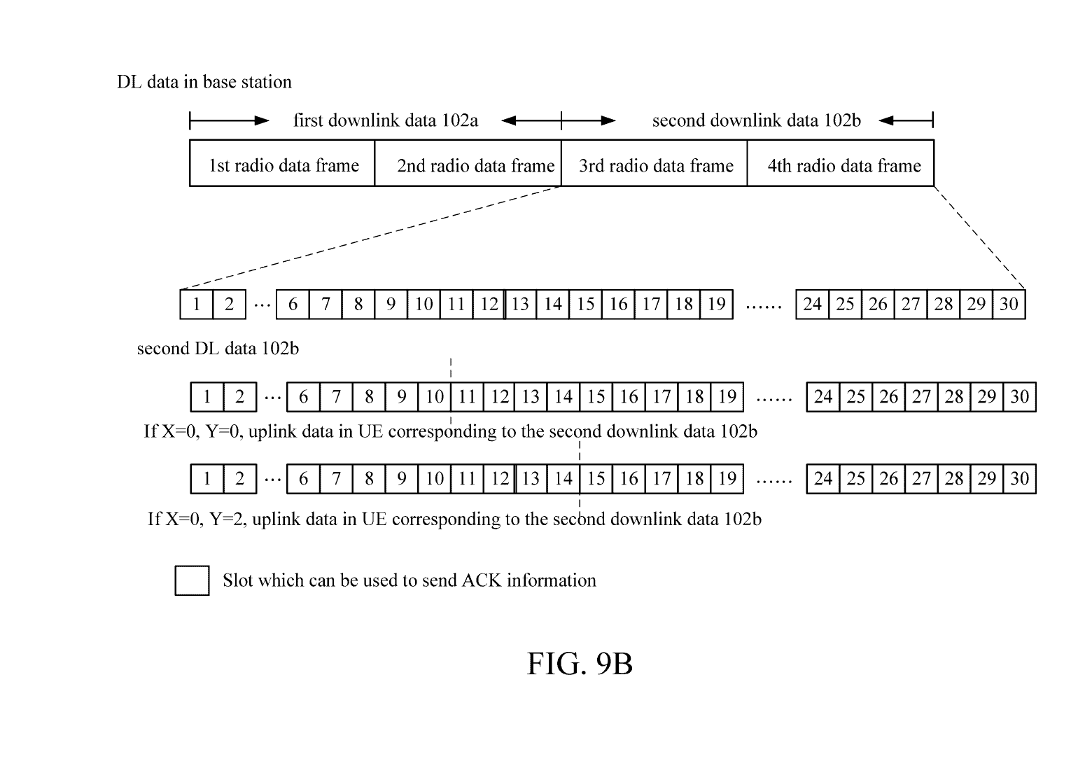

The tenth embodiment of the present invention is depicted in FIGS. 9A-9B. After getting the decoding result, as previously described, the UE 1 would transmit the acknowledgement (ACK) information indicating the decoding result to the base station 9. Each ACK information is carried in pairwise slots of an uplink dedicated physical control channel (UL DPCCH).

FIG. 9A depicts the slots of the uplink data, which corresponds to the first downlink data 102a and can be used to send ACK information in both cases that Y is equal or not equal to 0 (i.e., Y=0 and Y=2). The ACK information indicates either an ACK response or a negative-acknowledgment (NACK) response according to the decoding results (i.e., whether the first DTCH has been decoded successfully or not based on the without-DCCH mode, or whether both the first DTCH and the DCCH have been decoded successfully or not based on the with-DCCH mode). It should be appreciated that, for purpose of explanation, this embodiment illustrates the first downlink data 102a and the second downlink data 102b defined in the UTRA release 12 standard; however, the present invention is not intended to limit the ACK information transmission under the specific standard. Undoubtedly, the concept of the present invention can also be implemented in different communication standards.

Specifically, in the case that the backward shift number Y is equal to 0 as described in the fifth embodiment, if the first DTCH has been decoded successfully based on the without-DCCH mode, the processor 103 fills ACK information that indicates an ACK response into pairwise slots of the UL DPCCH. Otherwise, the processor 103 fills ACK information that indicates a NACK response into pairwise slots of the UL DPCCH. Since the processor 103 initiates the first early decoding procedure after 10 slots of the first downlink data 102a have been received by the transceiver 101, the earliest chance to fill ACK information into pairwise slots of the UL DPCCH is at Slots #11 and #12.

In the case that Y is not equal to 0 as described in the sixth embodiment, if the first DTCH has been decoded successfully based on the without-DCCH mode, or both the first DTCH and the DCCH have been decoded successfully based on the with-DCCH mode, the processor 103 fills ACK information that indicates an ACK response into pairwise slots of the UL DPCCH. Otherwise, the processor 103 fills ACK information that indicates a NACK response into pairwise slots of the UL DPCCH. For example, when Y=2, the processor 103 initiates the first early decoding procedure after 14 slots of the first downlink data 102a have been received by the transceiver 101; thus, the earliest chance to fill ACK information into pairwise slots of the UL DPCCH is at Slots #15 and #16.

Similarly, FIG. 9B depicts the slots of the uplink data which corresponds to the second downlink data 102b and can be used to send ACK information in both cases that the backward shift number Y is equal or not equal to 0 (i.e., Y=0 and Y=2). The ACK information indicates either an ACK response or a NACK response according to a decoding result of the second downlink data 102b (i.e., whether the second DTCH has not been decoded successfully or not based on the without-DCCH mode, or whether both the second DTCH and the DCCH have been decoded successfully or not based on the with-DCCH mode).

Specifically, in the case that the backward shift number Y is equal to 0 as described in the seventh embodiment, if the second DTCH has been decoded successfully based on the without-DCCH mode, the processor 103 fills ACK information that indicates an ACK response into pairwise slots of the UL DPCCH. Otherwise, the processor 103 fills ACK information that indicates a NACK response into pairwise slots of the UL DPCCH. Since the processor 103 initiates the second early decoding procedure after 10 slots of the second downlink data 102b have been received by the transceiver 101, the earliest chance to fill ACK information into pairwise slots of the UL DPCCH is at Slots #11 and #12.

Besides, in the case that the backward shift number Y is also equal to 0 as described in the eighth embodiment, if the second DTCH has been decoded successfully based on the without-DCCH mode or both the second DTCH and the DCCH have been coded successfully based on the with-DCCH mode, the processor 103 fills ACK information that indicates an ACK response into pairwise slots of the UL DPCCH. Otherwise, the processor 103 fills ACK information that indicates a NACK response into pairwise slots of the UL DPCCH. Likewise, since the processor 103 initiates the second early decoding procedure after 10 slots of the second downlink data 102b have been received by the transceiver 101, the earliest chance to fill ACK information into pairwise slots of the UL DPCCH is at Slots #11 and #12.

In the case that Y is not equal to 0 as described in the ninth embodiment, if the second DTCH has been decoded successfully based on the without-DCCH mode, or both the second DTCH and the DCCH have been decoded successfully based on the with-DCCH mode, the processor 103 fills ACK information that indicates an ACK response into pairwise slots of the UL DPCCH. Otherwise, the processor 103 fills ACK information that indicates a NACK response into pairwise slots of the UL DPCCH. For example, when Y=2, the processor 103 initiates the second early decoding procedure after 14 slots of the second downlink data 102b have been received by the transceiver 101; thus, the earliest chance to fill ACK information into pairwise slots of the UL DPCCH is at Slots #15 and #16.

It should be appreciated that the present invention is not intended to limit how the processor 103 fills the ACK information into the UL DPCCH. In an embodiment, the processor 103 may also fill the ACK information into a single slot of the UL DPCCH, instead of pairwise slots of the UL DPCCH. In an embodiment, the processor 103 may stop filling the ACK information into the UL DPCCH when the early decoding procedure ends up (in this case, the last chance to fill ACK information into pairwise slots of the UL DPCCH is at Slots #27 and #28). And, in an embodiment, the processor 103 may fill the ACK information that indicates an ACK response into the remaining slots of the UL DPCCH once the ACK information that indicates an ACK response has been filled into the previous pairwise slots of the UL DPCCH.

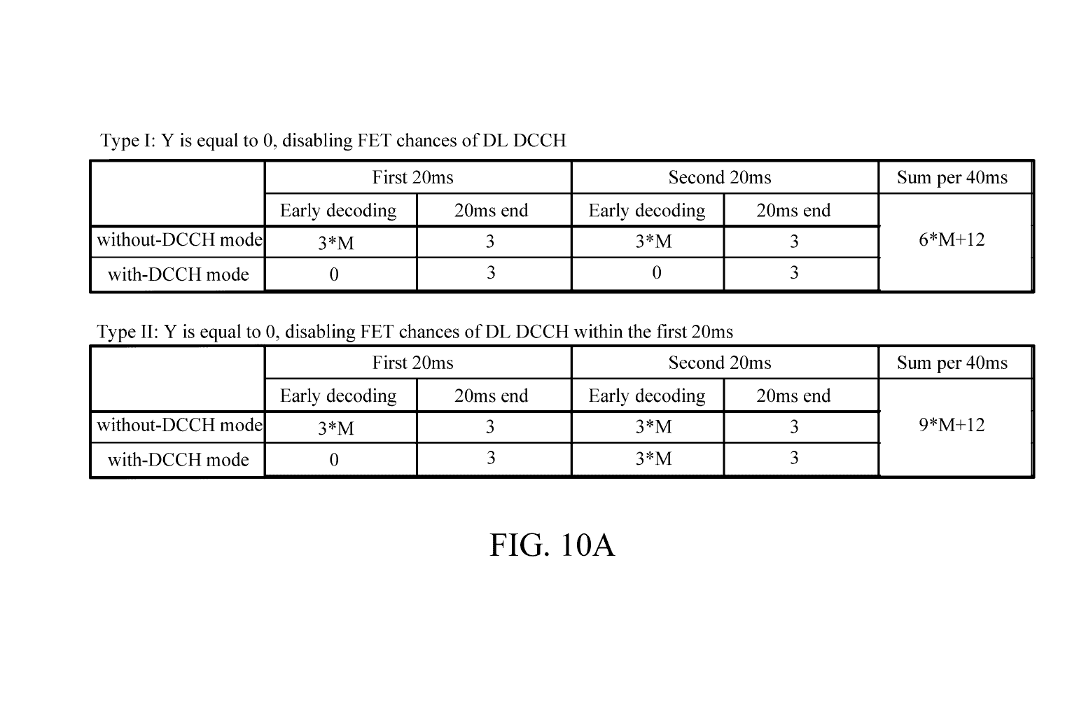

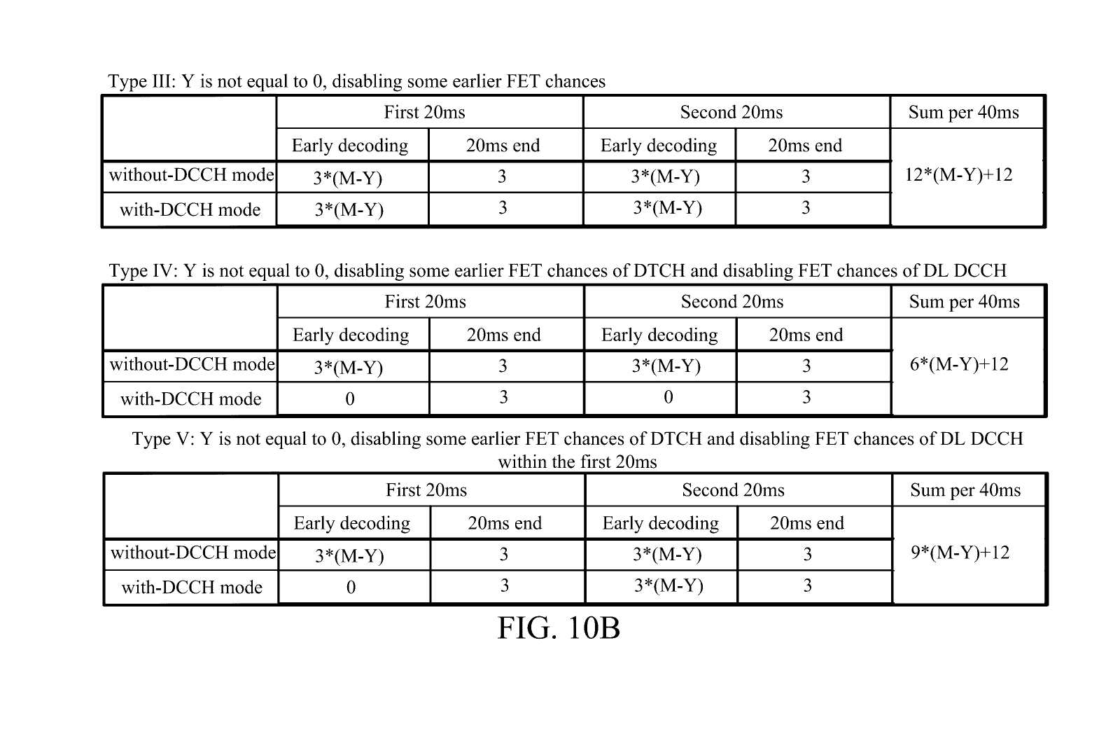

Besides, as aforementioned, the processor 103 shall decode the first DTCH and/or the DCCH again at the end of the first 20 ms as long as the first DTCH and/or the DCCH have not been decoded successfully during the first early decoding procedure. And, the processor 103 shall decode the second DTCH and/or the DCCH again at the end of the last 20 ms as long as the second DTCH and/or the DCCH have not been decoded successfully. In general, FIGS. 10A and 10B are tables which depict the number of decoding trials in the worst cases corresponding to the early decoding method described in the previous embodiments of the present invention. As previously described, taking AMR 12.2k as an example, the conventional UE needs to early decode the DTCH and the DCCH by trying all possible six decoding patterns: mute DTCH with DCCH, mute DTCH without DCCH, SID DTCH with DCCH, SID DTCH without DCCH, FRS DTCH with DCCH and FRS DTCH without DCCH on the downlink data. Thus, in the worst case, the Sum of decoding trials per 40 ms (i.e., within the first downlink data and the second downlink data) for the conventional UE is 12*M+12, where M=9+X. Unlike the conventional early decoding mechanism, the present invention reduces the Sum of decoding trials per 40 ms in the worst case as illustrated in FIGS. 10A and 10B.

In the type I, the UE 1 disables FET chances of early decoding the downlink data which includes both the DTCH and the DCCH over 40 ms as depicted in the fifth and seventh embodiments. Thus, the sum of decoding trials per 40 ms in the worst case of the type I is reduced from 12*M+12 to 6*M+12 (almost 50% reduction). In the type II, the UE 1 disables FET chances of early decoding the downlink data which includes both the DTCH and the DCCH over first 20 ms as depicted in the fifth and eighth embodiments. Thus, the sum of decoding trials per 40 ms in the worst case of the type II is reduced from 12*M+12 to 9*M+12 (almost 25% reduction). Owing to the low DCCH occurrence probability (DCCH is transmitted only when there is control message to be transmitted to the UE 1), disabling FET chances of early decoding the downlink data which includes both the DCCH and the DTCH in the type I and the type II introduces almost no link gain loss, which means that the performance of the DL-FET is not degraded.

In the type III, the UE 1 disables some earlier FET chances of early decoding the DTCH or both the DTCH and the DCCH by postponing the timing of executing the early decoding procedure as depicted in the sixth and ninth embodiments. Thus, the sum of decoding trials per 40 ms in the worst case of the type III is reduced to 12*(M−Y)+12. Besides, in the type IV, the UE 1 disables FET chances of early decoding the downlink data which includes both the DTCH and the DCCH over 40 ms. Moreover, the UE 1 further disables some earlier FET chances of early decoding the DTCH by postponing the timing of using the without-DCCH mode to early decode the DTCH.

Unlike the type IV, the UE 1 in the type V disables FET chances of early decoding the downlink data which includes both the DTCH and the DCCH only within the first 20 ms of the downlink data. However, during the second 20 ms of the downlink data, the UE 1 is configured to disable some earlier FET chances of early decoding the DCCH by postponing the timing of using the with-DCCH mode to early decode the DCCH instead of skipping the with-DCCH mode as the type IV. It should be appreciated that the UE 1 may be configured to execute the early decoding method based on only one of the type I, type II, type III, type IV and type V early decoding mechanism by the manufacturer. In other embodiments, the base station 9 may coordinate with the UE 1 in advance to determine that the UE 1 shall utilize which type early decoding mechanism to execute the early decoding procedure so that the UE 1 may be adaptively configured to one of the three types (i.e., type I, type II, type III, type IV and type V) of early decoding mechanism.

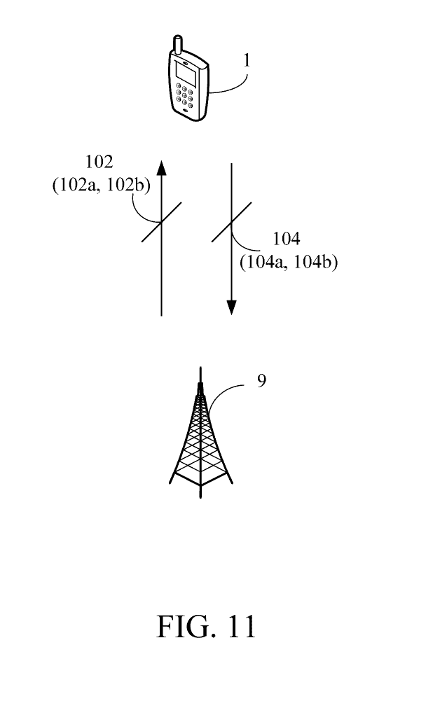

The eleventh embodiment of the present invention is depicted in FIG. 11, which illustrates a schematic diagram showing data transmission between the base station 9 and the UE 1 of the present invention. As previously described, the base station 9 transmits the first downlink data 102a and the second downlink data 102b to the UE 1 and receives uplink data 104 from the UE 1. The uplink data 104 may include first ACK information 104a, which indicates whether the first downlink data 102a has been decoded successfully or not, and second ACK information 104b, which indicates whether the second downlink data 102b has been decoded successfully or not. It shall be appreciated the base station 9 could have a transceiver for transmitting and receiving signal to/from a UE and a processor for executing the operations as follows.

While transmitting the first downlink data 102a to the UE 1, the base station 9 also retrieves first ACK information 104a from pairwise slots of the UL DPCCH corresponding the first downlink data 102a. When the first ACK information 104a indicates an ACK response, the base station 9 terminates transmitting a remaining part of the first downlink data 102a to the user equipment. Likewise, while transmitting the second downlink data 102b to the UE 1, the base station 9 also retrieves second ACK information 104b from pairwise slots of the UL DPCCH corresponding the second downlink data 102b. When the second ACK information 104b indicates an ACK response, the base station 9 terminates transmitting a remaining part of the second downlink data 102b to the user equipment.

In addition, the UE 1 may inform the base station 9 in advance of the type of the early decoding procedure being used. In such a case that when the UE 1 uses the type I of the early decoding procedure and both the first downlink data 102a and the second downlink data 102b include the DCCH, the base station 9 learns that the UE 1 is unable to early decode the first downlink data 102a and the second downlink data 102b successfully (since the UE 1 decodes the first downlink data 102a and the second downlink data only based on without-DCCH mode). In this situation, the base station 9 can ignore the ACK information transmitted from the UE 1 so as to prevent ACK or NACK false alarm. In other words, the base station 9 disables retrieving the first ACK information 104a from pairwise slots of the UL DPCCH corresponding the first downlink data 102a and retrieving the second ACK information 104b from pairwise slots of the UL DPCCH corresponding the second downlink data 102b when the first downlink data 102a and the second downlink data 102b include the DCCH.

In other embodiments, the base station 9 may be configured to disable retrieving ACK information (i.e., the first ACK information and the second ACK information) when the base station 9 transmits the downlink data which includes the DCCH to the UE 1. In this embodiment, the base station 9 would configure the UE 1 to use the type I of the early decoding procedure once there is DCCH to be transmitted to the UE 1.

Similarly, in the case that the UE 1 uses the type II of the early decoding procedure and the first downlink data 102a includes the DCCH, the base station 9 can learn that the UE 1 is unable to early decode the first downlink data 102a (since the UE 1 decodes the first downlink data 102a only based on without-DCCH mode) and ignore the first ACK information 104a transmitted from the UE 1 so as to prevent ACK or NACK false alarm. In other words, the base station 9 disables retrieving the first ACK information 104a from pairwise slots of the UL DPCCH corresponding the first downlink data 102a when the first downlink data 102a includes the DCCH.

According to the above descriptions, the early decoding mechanism of the present invention can reduce decoding complexity of the UE with almost no DL link gain loss when performing the DL-FET and using BTFD. In addition, the present invention can allow the base station to ignore the ACK information transmitted from the UEs when the downlink data includes DCCH and the UEs only utilizes without-DCCH mode to perform the early decoding procedure so as to prevent ACK or NACK false alarm.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A user equipment, comprising:
a transceiver, being configured to receive a first downlink data and a second downlink data from a base station, wherein the second downlink data comes after the first downlink data; and
a processor, being electrically connected to the transceiver and configured to perform a first early decoding procedure after an initial number of slots of the first downlink data have been received by the transceiver;
wherein the first early decoding procedure comprises the following steps:
early decoding a first dedicated traffic channel (DTCH) from received slots of the first downlink data based on a without-dedicated control channel (DCCH) mode after a first number of slots of the first downlink data have been received by the transceiver;
disabling early decoding at least one of the first DTCH and a DCCH based on a with-DCCH mode until a second number of slots of the first downlink data have been received by the transceiver.

2. The user equipment as claimed in claim 1, wherein the first number of slots of the first downlink data is equal to the initial number of slots of the first downlink data, and the second number of slots of the first downlink data is equal to a total number of slots of the first downlink data.

3. The user equipment as claimed in claim 1, wherein the first number of slots of the first downlink data is greater than the initial number of slots of the first downlink data, and the second number of slots of the first downlink data is equal to the first number of slots of the first downlink data.

4. The user equipment as claimed in claim 1, wherein the processor is further configured to execute the following step:
decoding the first DTCH from the first downlink data based on the without-DCCH mode and the with-DCCH mode after total slots of the first downlink data have been received by the transceiver unless the first DTCH has been decoded successfully.

5. The user equipment as claimed in claim 1, wherein the processor is further configured to execute the following step:
filling acknowledgement (ACK) information into pairwise slots of an uplink dedicated physical control channel (UL DPCCH);
wherein the ACK information indicates either an ACK response or a negative-acknowledgment (NACK) response according to whether the first DTCH has been decoded successfully based on the without-DCCH mode or not, or whether the first DTCH and the DCCH have been decoded successfully based on the with-DCCH mode or not.

6. The user equipment as claimed in claim 1, wherein the processor is further configured to perform a second early decoding procedure after an initial number of slots of the second downlink data have been received by the transceiver, and the second early decoding procedure comprises the following steps:
decoding a second DTCH from received slots of the second downlink data based on the without-DCCH mode after a first number of slots of the second downlink data have been received by the transceiver; and
decoding the second DTCH from the received slots of the second downlink data and the DCCH from the first downlink data and the received slots of the second downlink data based on the with-DCCH mode after a second number of slots of the second downlink data have been received by the transceiver;
wherein the first number of slots of the second downlink data is equal to or greater than the initial number of slots of the second downlink data, and the second number of slots of the second downlink data is equal to or greater than the first number of slots of the second downlink data.

7. The user equipment as claimed in claim 6, wherein the first number of slots of the second downlink data is equal to the initial number of slots of the second downlink data, and the second number of slots of the second downlink data is a total number of slots of the second downlink data.

8. The user equipment as claimed in claim 6, wherein the processor is further configured to execute the following steps:
decoding the second DTCH from the second downlink data based on the without-DCCH mode and the with-DCCH mode after total slots of the second downlink data have been received by the transceiver unless the second DTCH has been decoded successfully; and
decoding the DCCH from the first downlink data and the second downlink data based on the with-DCCH mode after the total slots of the second downlink data have been received by the transceiver unless the second DTCH has been decoded successfully based on the without-DCCH mode or the DCCH has been decoded successfully based on the with-DCCH mode.

9. The user equipment as claimed in claim 6, wherein the processor is further configured to execute the following step:
filling ACK information into pairwise slots of an uplink dedicated physical control channel (UL DPCCH);
wherein the ACK information indicates either an ACK response or a NACK response according to whether the second DTCH has not been decoded successfully or not based on the without-DCCH mode, or whether both the second DTCH and the DCCH have been decoded successfully or not based on the with-DCCH mode.

10. An early decoding method for use in a user equipment, the user equipment comprising a transceiver and a processor, the transceiver being configured to receive a first downlink data and a second downlink data from a base station, and the second downlink data coming after the first downlink data, the processor being electrically connected to the transceiver, the early decoding method being executed by the processor and comprising the following step:
performing a first early decoding procedure after the transceiver receives an initial number of slots of the first downlink data, wherein the first early decoding procedure comprises the following steps:
early decoding a first dedicated traffic channel (DTCH) from received slots of the first downlink data based on a without-dedicated control channel (DCCH) mode after a first number of slots of the first downlink data have been received by the transceiver;
disabling early decoding at least one of the first DTCH and a DCCH based on a with-DCCH mode until a second number of slots of the first downlink data have been received.

11. The early decoding method as claimed in claim 10, wherein the first number of slots of the first downlink data is equal to the initial number of slots of the first downlink data, and the second number of slots of the first downlink data is a total number of slots of the first downlink data.

12. The early decoding method as claimed in claim 10, wherein the first number of slots of the first downlink data is greater than the initial number of slots of the first downlink data, and the second number of slots of the first downlink data is equal to the first number of slots of the first downlink data.

13. The early decoding method as claimed in claim 10, further comprising the following step:
decoding the first DTCH from the first downlink data based on the without-DCCH mode and the with-DCCH mode after total slots of the first downlink data have been received by the transceiver unless the first DTCH has been decoded successfully.

14. The early decoding method as claimed in claim 10, further comprising the following steps:
filling acknowledgement (ACK) information into pairwise slots of an uplink dedicated physical control channel (UL DPCCH);
wherein the ACK information indicates either an ACK response or a negative-acknowledgment (NACK) response according to whether the first DTCH has been decoded successfully or not based on the without-DCCH mode, or whether the first DTCH and the DCCH have been decoded successfully or not based on the with-DCCH mode.

15. The early decoding method as claimed in claim 10, further comprising the following step:
performing a second early decoding procedure after an initial number of slots of the second downlink data have been received by the transceiver, wherein the second early decoding procedure comprises the following steps:
decoding a second DTCH from received slots of the second downlink data based on the without-DCCH mode after a first number of slots of the second downlink data have been received by the transceiver; and
decoding the second DTCH from the received slots of the second downlink data and the DCCH from the first downlink data and the received slots of the second downlink data based on the with-DCCH mode after a second number of slots of the second downlink data have been received by the transceiver;
wherein the first number of slots of the second downlink data is equal to or greater than the initial number of slots of the second downlink data, and the second number of slots of the second downlink data is equal to or greater than the first number of slots of the second downlink data.

16. The early decoding method as claimed in claim 15, wherein the first number of slots of the second downlink data is equal to the initial number of slots of the second downlink data, and the second number of slots of the second downlink data is a total number of slots of the second downlink data.

17. The early decoding method as claimed in claim 15, further comprising the following steps:
decoding the second DTCH from the second downlink data based on the without-DCCH mode and the with-DCCH mode after total slots of the second downlink data have been received by the transceiver unless the second DTCH has been decoded successfully; and
decoding the DCCH from the first downlink data and the second downlink data based on the with-DCCH mode after the total slots of the second downlink data have been received by the transceiver unless the second DTCH has been decoded successfully based on the without-DCCH mode or the DCCH has been decoded successfully.

18. The early decoding method as claimed in claim 15, further comprising the following step:
filling ACK information into pairwise slots of an uplink dedicated physical control channel (UL DPCCH);
wherein the ACK information indicates either an ACK response or a NACK response according to whether the second DTCH has been decoded successfully or not based on the without-DCCH mode, or whether both the second DTCH and the DCCH have been decoded successfully or not based on the with-DCCH mode.

19. A base station as claimed in claim 1, being configured to retrieve first ACK information from pairwise slots of an UL DPCCH corresponding to the first downlink data and terminate transmitting a remaining part of the first downlink data to the user equipment when the first ACK information indicates an ACK response, and further being configured to retrieve second ACK information from pairwise slots of an UL DPCCH corresponding to the second downlink data and terminate transmitting a remaining part of the second downlink data to the user equipment when the second ACK information indicates an ACK response, wherein the base station is further configured to disable retrieving the first ACK information from pairwise slots of an UL DPCCH corresponding to the first downlink data when the first downlink data includes the DCCH.

20. A base station as claimed in claim 19, further being configured to disable retrieving the second ACK information from pairwise slots of an UL DPCCH corresponding to the second downlink data when the second downlink data includes the DCCH.
